(19) United States
(12) Patent Application Publication
(10) Pub. No.: US 2008/0025026 A1
(43) Pub. Date: Jan. 31, 2008

(54) Object with rotational effect

(75) Inventors: Kuo-Vicent Lee, Taipei (TW); Ho-Hsin Liao, Taipei (TW)

Correspondence Address: BACON & THOMAS, PLLC, 625 SLATERS LANE, FOURTH FLOOR, ALEXANDRIA, VA, 22314, US

(73) Assignee: BENEXT INNO-PRODUCT DEVELOPMENT LTD., Taipei (TW)

(21) Appl. No.: 11/512,115

(22) Filed: Aug. 30, 2006

(30) Foreign Application Priority Data
Jul. 7, 2006 (TW) 095124926

(51) Int. Cl. F21V 33/00

(52) U.S. Cl. 362/253

(57) ABSTRACT

An object with a rotational effect includes an outer enclosure shell, a base, a first inner object and a rotation device. The first inner object is located inside the outer enclosure shell. A liquid is filled between the first inner object and the outer enclosure shell. The base includes a power supply to transmit electrical power to the first inner object. The first inner object comprises a first enclosure shell, at least one illumination member and a power receiving member. The power receiving member receives electrical power from the power supply, and supplies electrical power to the illumination member. The rotation device rotates the first enclosure shell.

### BACKGROUND OF THE INVENTION

1. Field of the Invention

The present invention relates an object with a rotational effect, which can be used as an ornament or a globe.

2. Description of the Related Art

U.S. Pat. No. 5,893,789 (entitled “Sphere Toy”) discloses a sphere toy, which comprises an outer spherical shell, an inner spherical shell, and a liquid that is disposed between the outer spherical shell and the inner spherical shell. A user can use a rotation control device to control the rotation of the inner spherical shell. However, U.S. Pat. No. 5,893,789 does not provide power to continuously rotate the inner spherical shell, and also does not provide a lighting device in the inner spherical shell.

### SUMMARY OF THE INVENTION

The present invention provides an object with a rotational effect that includes an outer enclosure shell, a base, a first inner object and a rotation device; the first inner object is located inside the outer enclosure shell. Additionally, a liquid fills a space between the first inner object and the outer enclosure shell.

The base includes a power supply member to transmit electrical power to the first inner object. The first inner object comprises a first enclosure shell, at least one illumination member and a power receiving member. The power receiving member receives electrical power from the power supply member, and supplies electrical power for the illumination member. In certain embodiments, power transmission between the power supply element and the power receiving element is performed by a coil.

The rotation device receives the power provided by the power supply element to continuously rotate the first enclosure shell. In various embodiments, the rotation device may be an eccentric motor in the first inner object, or rotation of the first enclosure shell may be achieved using magnetism.

One of the embodiments of the present invention may be used as a globe. To prevent the illumination element from moving with the first enclosure shell, a second enclosure shell and a second liquid may be disposed between the first enclosure shell and the second enclosure shell, with the illumination element disposed in the second enclosure shell. This embodiment can achieve a special effect that can be found at the webpage www.mpegla.com/index1.cfm (i.e. a rotational globe).

Other objects, advantages, and novel features of the invention will become more apparent from the following detailed description when taken in conjunction with the accompanying drawings.

### BRIEF DESCRIPTION OF THE DRAWINGS

FIG. 1 is a cross-sectional drawing of a first embodiment of an object with a rotational effect according to the present invention.

FIG. 2 is a cross-sectional drawing of a second embodiment of an object with a rotational effect according to the present invention.

FIG. 3 is a cross-sectional drawing of a third embodiment of an object with a rotational effect according to the present invention.

FIG. 4 is a cross-sectional drawing of a fourth embodiment of an object with a rotational effect according to the present invention.

FIG. 5 is a circuit diagram of the fourth embodiment of an object with rotational effect object according to the present invention.

FIGS. 6˜7 are perspective views of the fourth embodiment of an object with rotational effect object as a globe with illumination effect.

FIG. 8 is a perspective view of a fifth embodiment of an object with a rotational effect according to the present invention

FIG. 9 is a perspective view of a sixth embodiment of an object with a rotational effect according to the present invention

FIG. 10 is a perspective view of a seventh embodiment of an object with a rotational effect according to the present invention.

FIG. 11 is a perspective view of an eighth embodiment of an object with a rotational effect according to the present invention.

### DETAILED DESCRIPTION OF THE PREFERRED EMBODIMENT

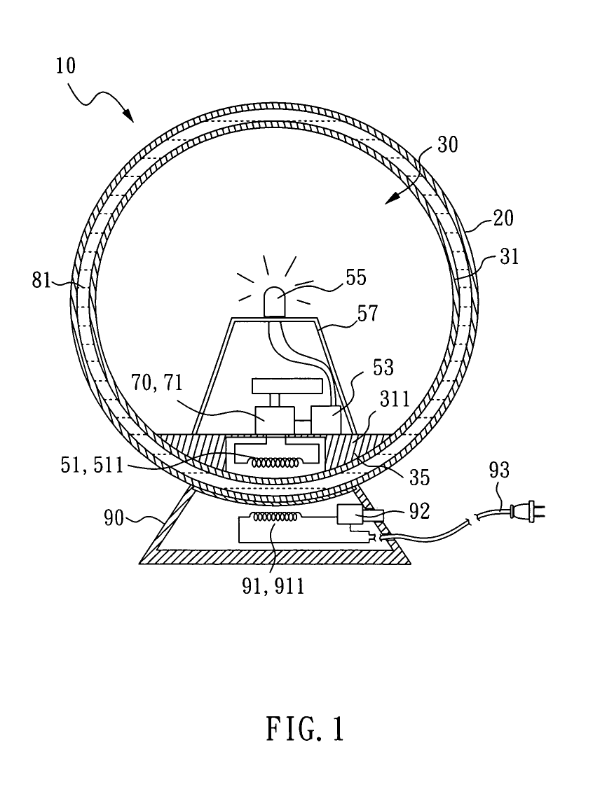

Please refer to FIG. 1 for a first embodiment. An object 10 having a rotational effect according to the present invention comprises three primary components: an outer enclosure shell 20, a base 90 and a first inner object 30. The first inner object 30 is disposed in the outer enclosure shell 20, and a first liquid 81 (such as water) is disposed in the space between the outer enclosure shell 20 and the first enclosure shell 31. The specific weight of the first inner object 30 is substantially equal to the specific weight of the first liquid 81 (the closer, the better) so that the first inner object 30 floats on or within the first liquid 81. If the first inner object 30 is too light, a heavier block 35 can be added onto the first inner object 30. Additionally, if the center of gravity of the first inner object 30 needs to be located lower within the object 30 to keep the bottom side 311 of the first inner object 30 pointed down, the heavier block 35 can be located on the bottom side 311, or close to the bottom side 311.

To display the first inner object 30, the entire, or a potion of, the outer enclosure shell 20 may be transparent or translucent. In this embodiment, the outer enclosure shell 20 has a spherical shape, and the first inner object 30 may also have a spherical shape. The outer enclosure shell 20 is not fixed onto the base 90 so that a user can pick up the outer enclosure shell 20 (and the first inner object 30 with it); however, the outer enclosure shell 20 may also be fixed onto the base 90.

The base 90 comprises a power supply element 91, a control switch 92 and a plug 93. In this embodiment, the power supply element 91 comprises a coil 911 which is used to send power to the first inner object 30. The base 90 may instead have a battery for the power supply, rather than utilizing the power plug 93.

The first inner object 30 comprises a first enclosure shell 31, at least one illumination element 55 (such as one or a plurality of LEDs) and a power receiving element 51. The illumination element 55 is disposed in the center of the first inner object 30. For example, the illumination element 55 may be fixed at a desired position by way of a frame 57. The first enclosure shell 31 may be completely or partially translucent, so that light from the illumination element 55 may disperse.

The power receiving element 51 comprises a coil 511; using electromagnetic induction between the coil 911 and the coil 511, the power receiving element 51 obtains power via the power supply element 91, and provides the power to the illumination element 55. This power transmission technology, utilizing coils without the need of a wired connection or physically connecting points, is a well known technology; the technology is used, for example, in RFIDs, electrical toothbrushes, and cell phone chargers, and so needs no further description.

The object 10 with a rotational effect of the present invention further comprises a rotation means 70 for rotating the first inner object 30. In the first embodiment, the rotation means 70 comprises an eccentric motor 71 disposed in the first inner object 30. When the eccentric motor 71 rotates, the first enclosure shell 31 also rotates. Since the first liquid 81 is disposed between the first enclosure shell 31 and the outer enclosure shell 20, the first enclosure shell 31 is very easy to rotate; therefore, even when the eccentric motor 71 rotates slowly, the first enclosure shell 31 still rotates.

In the first embodiment, the first inner object 30 further comprises a storage element 53 (such as a capacitor or a battery) electrically connected to the power receiving element 51. For example, when the user picks up the outer enclosure shell 20 and walks away from the base 90, although the power receiving element 51 is then unable to obtain power from the power supply element 91, the storage element 53 can continue to provide power to the eccentric motor 71 and to the illumination element 55 for a period of time. Of course, when the control switch 92 turns off the power supply element 91, the storage element 53 can also continue to provide power.

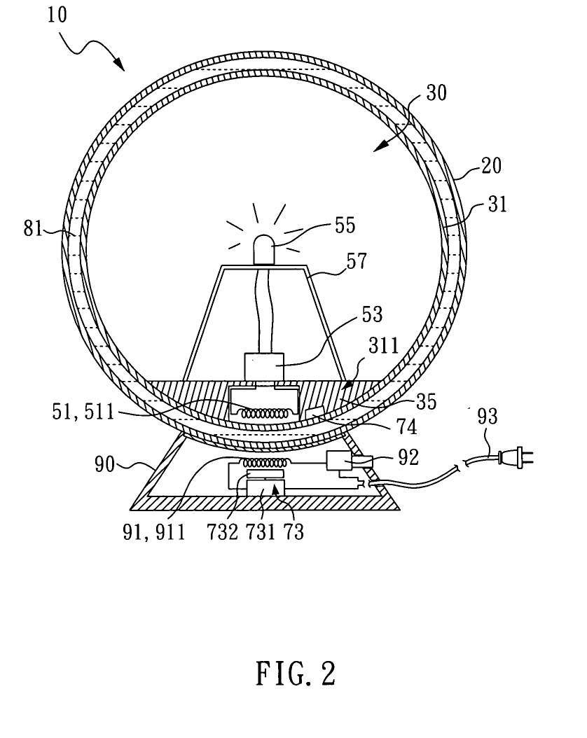

Please refer to FIG. 2 for a second embodiment. A difference between the second embodiment and the first embodiment is the use of a different rotation means 70. The rotation means 70 in the second embodiment has a magnetic driver 73 disposed on the base 90, which generates an variable magnetic field. The magnetic driver 73 in the second embodiment is a motor 731 electrically connected to the power supply element 91 and a first magnetic object 732. The motor 731 drives the first magnetic object 732 to create the variable magnetic field. The rotation means 70 further comprises a second magnetic object 74 disposed at the bottom side 311 of the first enclosure shell 31, so that the variable magnetic field generated by the magnetic driver 73 drives the second magnetic object 74 to rotate the first enclosure shell 31. U.S. Pat. No. 5,893,789 (entitled “Sphere Toy”) disclosures the technology of utilizing magnetic power to rotate objects. The first magnetic object 732 and the second magnetic object 74 may both be magnetic, or one of them may be magnetic and the other may be magnetic force affected material such as iron.

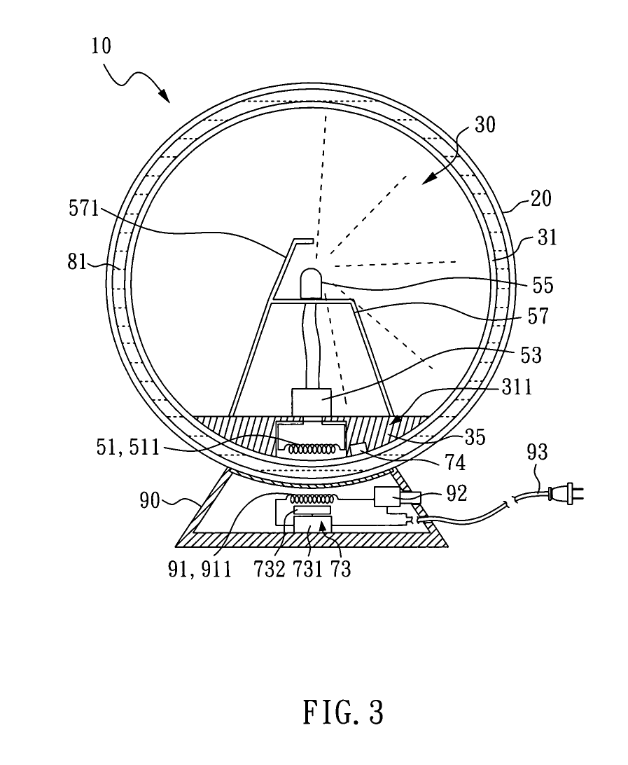

Please refer to FIG. 3 a third embodiment. A difference between the third embodiment and the second embodiment is that the third embodiment further comprises a shielding element 571 to limit the light radiating from the illumination element 55. As a result, only a portion of the first enclosure shell 31 is directly illuminated by the illumination element 55. When the first enclosure shell 31 rotates, the illuminated portion of the first enclosure shell 31 rotates as well, which creates a flashing effect. Of course, the shielding element 571 is not necessary for this effect. By way of example, let LED(S) face one particular direction.

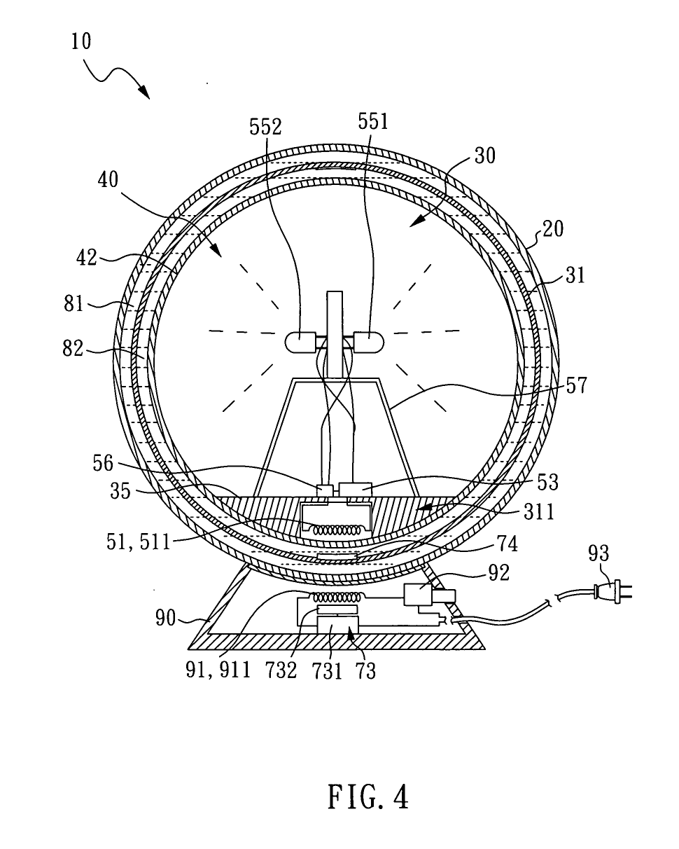

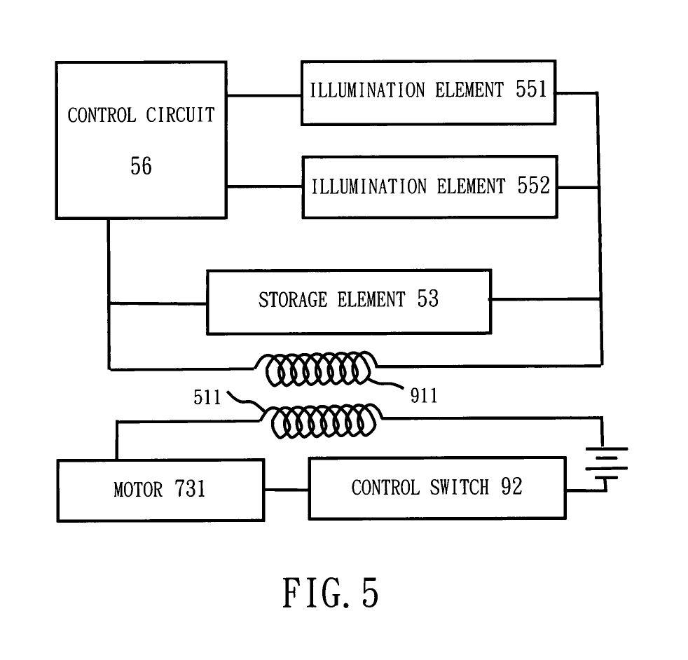

Please refer to FIG. 4 to FIG. 7 for a fourth embodiment. In the fourth embodiment, the first inner object 30 further comprises a second inner object 40, and the second inner object 40 further comprises a second enclosure shell 42 on the outermost portion of the second inner object 40. The first inner object 30 further comprises a second liquid 82 disposed between the first enclosure shell 31 and the second enclosure shell 42, with a specific weight of the second inner object 40 being substantially identical to the specific weight of the second liquid 82.

The heavier block 35, illumination element 551, illumination element 552, power receiving element 51, control circuit 56 and the frame 57 are all disposed in the second enclosure shell 42.

The rotation means in the fourth embodiment may be identical to the rotation means in the second and third embodiments, utilizing magnetic power to rotate the first enclosure shell 31. The second magnetic object 74 is disposed at a position near the base 90 on the first enclosure shell 31 to be affected by the first magnetic object 732.

The illumination element 551 and the illumination element 552 face in different directions; the user may use the control switch 92 and the control circuit 56 (such as a chip or a simple logic circuit) to control the illumination element 551 and the illumination element 552 so that both are turned on, or just one of the illumination elements is turned on. Although the control switch 92 is not directly connected to the control circuit 56, the control switch 92 can still send a signal to the control circuit 56 via currents or signals having different frequencies (such as is used in RFID technology).

In the fourth embodiment, when the first enclosure shell 31 rotates, the second enclosure shell 42 stays still or moves relatively slowly. Following description explains the benefits provided by the fourth embodiment.

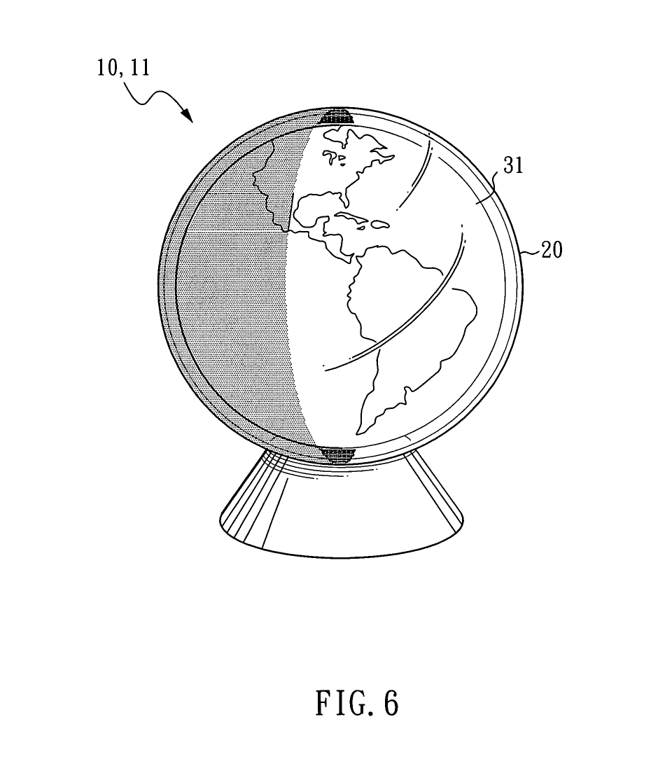

If only the illumination element 551 is turned on, while the illumination element 552 is turned off, and if the first enclosure shell 31 is covered by a map of the earth, the object 10 becomes a globe 11. With reference to FIG. 6, a portion of the surface of the globe 11 is illuminated or is relatively brighter (as shown in right side, the American continental region). When the first enclosure shell 31 rotates to the area shown in FIG. 7 (the African and Asian continental areas), since the second enclosure shell 42 remains stationary (or rotates relatively very slowly), the right side of the globe 11 remains illuminated or relatively brighter. Such appearance effect can be found at the webpage www.mpegla.com/index1.cfm (i.e. a rotational globe).

If the object 10 with a rotational effect in the third embodiment is also a globe 11, the illuminated or brighter area on the earth surface in the third embodiment rotates with the first enclosure shell 31, which means the brighter will stay on the same area (e.g. the American continental region keeps brighter). Then the effect will be different from that of a rotational globe shown on the webpage www.mpegla.com/index1.cfm.

To provide a cloud-like effect for the globe, another white liquid (which does not dissolve in the first liquid 81) may be added into the first liquid 81.

The outer enclosure shell 20 and the first inner object 30 in the above first to fourth embodiments all have a spherical shape; however, it will be appreciated that various shapes may be employed, as illustrated in the following fifth to eighth embodiments.

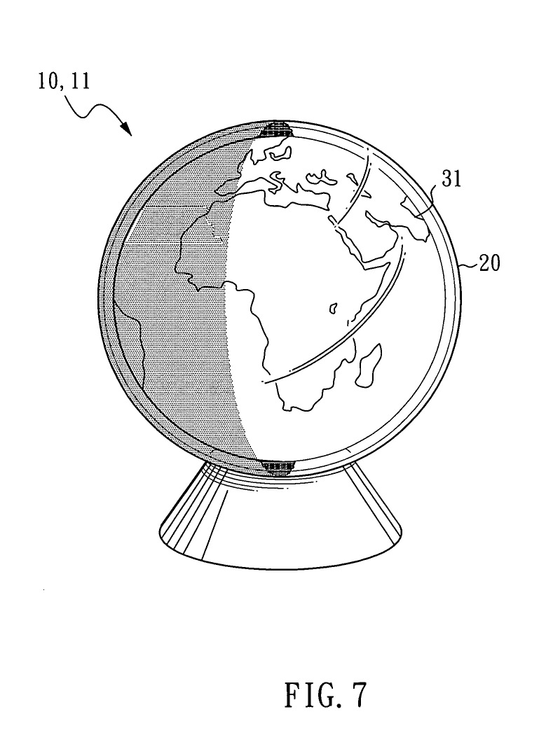

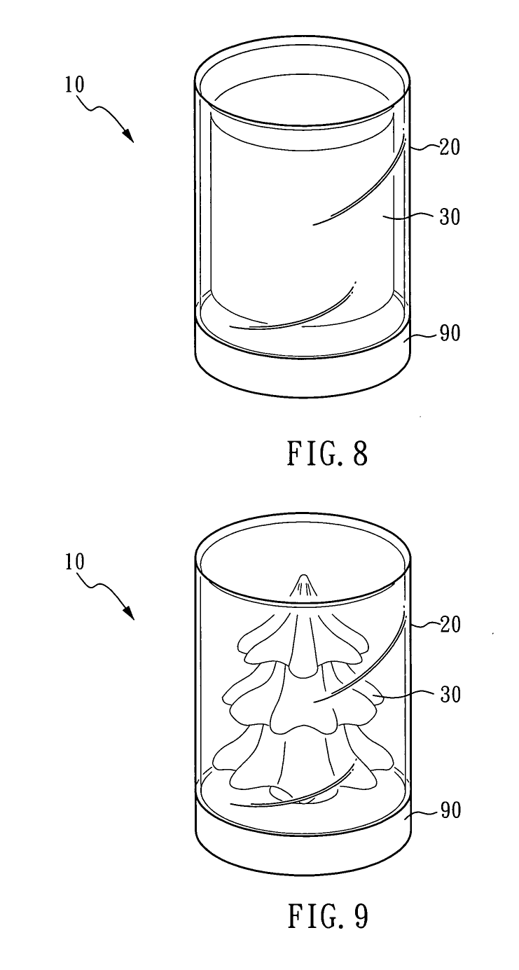

With reference to FIG. 8, in the fifth embodiment, the outer enclosure shell 20 and the first inner object 30 in the object 10 each have a round, columnar shape.

With reference to FIG. 9, in the sixth embodiment, the outer enclosure shell 20 in the object 10 has a round columnar shape, and the first inner object 30 has the shape of a Christmas tree.

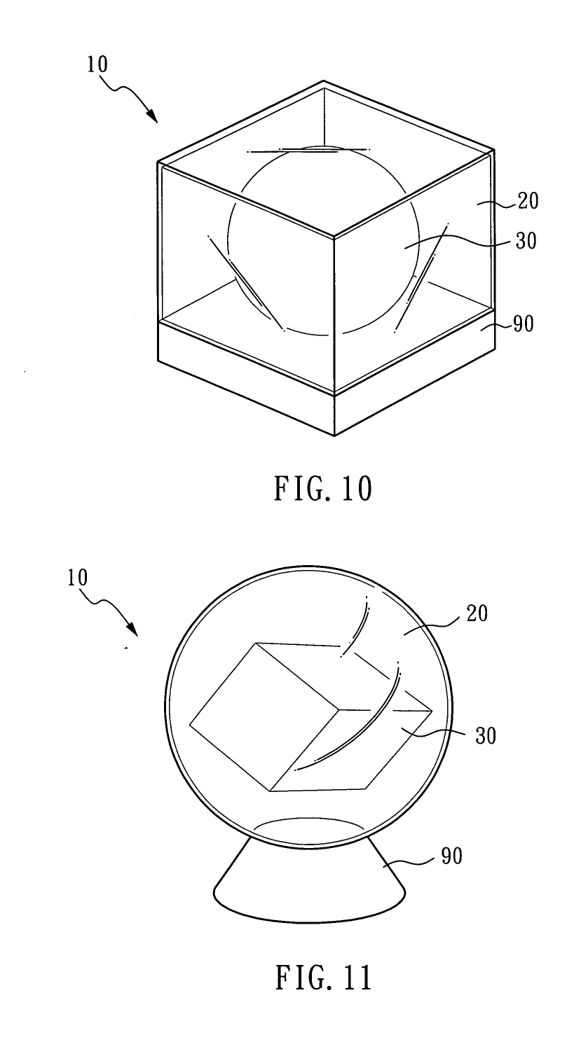

With reference to FIG. 10, in the seventh embodiment, the outer enclosure shell 20 in the object 10 has a cubic shape, and the first inner object 30 has a spherical shape.

Please refer to FIG. 11 for an eighth embodiment. In the eighth embodiment, the outer enclosure shell 20 in the object 10 has a spherical shape, and the first inner object 30 has a cubic shape.

Although the present invention has been explained in relation to its preferred embodiments, it is to be understood that many other possible modifications and variations can be made without departing from the spirit and scope of the invention as hereinafter claimed. For example, the base 90 can also be disposed above the outer enclosure shell 20, and the power receiving element 51 of the first inner object 30 could be moved up to be close to the base 90.

What is claimed is:

1. An object with a rotational effect comprising:
an outer enclosure shell, wherein at least a portion of the outer enclosure shell is transparent or translucent;
a base comprising a power supply element, the outer enclosure shell capable of being disposed on the base;
a first inner object located in the outer enclosure shell, wherein the first inner object comprises a first enclosure shell, the first enclosure shell disposed outside of the first inner object;
a first liquid disposed between the first inner object and the outer enclosure shell, a specific weight of the first inner object being substantially equal to a specific weight of the first liquid; and
a rotation means for receiving power provided by the power supply element to continuously rotate the first enclosure shell.

2. The object with a rotational effect as claimed in claim 1, wherein the first inner object further comprises a power receiving element which is used for receiving the power provided by the power supply element.

3. The object with a rotational effect as claimed in claim 2, wherein the first inner object further comprises at least one illumination element, the illumination element disposed in the first enclosure shell, the power receiving element providing power to the at least one illumination element.

4. The object with a rotational effect as claimed in claim 2, wherein the rotation means further comprises an eccentric motor disposed in the first inner object, the power receiving element providing power to the eccentric motor so that the eccentric motor causes the first enclosure shell to rotate.

5. The object with a rotational effect as claimed in claim 1, wherein the rotation means further comprises:
a magnetic driver for generating an variable magnetic field, the magnetic driver disposed in the base; and
at least one second magnetic object disposed at the bottom of the first enclosure shell, the variable magnetic field generated by the magnetic driver driving the second magnetic object to rotate the first enclosure shell.

6. The object with a rotational effect as claimed in claim 3 wherein the number of illumination element is multiple, the base further comprising a control switch, and the control switch controls at least one of the illumination elements to illuminate.

7. The object with a rotational effect as claimed in claim 3, wherein the first inner object further comprises:
a second inner object, the second inner object having a second enclosure shell; and
a second liquid disposed between the first enclosure shell and the second enclosure shell, a specific weight of the second inner object being substantially equal to a specific weight of the second liquid; and wherein:
the at least one illumination element is disposed in the second enclosure shell; and
the power receiving element is disposed in the second enclosure.

8. The object with a rotational effect as claimed in claim 7, wherein the rotation means further comprises:
a magnetic driver for generating an variable magnetic field, the magnetic driver disposed in the base; and
at least one second magnetic object disposed at the bottom of the first enclosure shell, the variable magnetic field generated by the magnetic driver driving the second magnetic object to rotate the first enclosure shell.

9. The object with a rotational effect as claimed in claim 7 wherein the number of illumination element is multiple, the base further comprising a control switch, and the control switch controls at least one of the illumination elements to illuminate.

10. The object with a rotational effect as claimed in claim 8 wherein the number of illumination element is multiple, the base further comprising a control switch, and the control switch controls at least one of the illumination elements to illuminate.

11. The object with a rotational effect as claimed in claim 1 is a globe.

12. The object with a rotational effect as claimed in claim 3 is a globe.

13. The object with a rotational effect as claimed in claim 4 is a globe.

14. The object with a rotational effect as claimed in claim 5 is a globe.

15. The object with a rotational effect as claimed in claim 7 is a globe.

16. The object with a rotational effect as claimed in claim 2, wherein the first inner object further comprises a storage element electrically connected to the power receiving element.

17. The object with a rotational effect as claimed in claim 3, wherein the first inner object further comprises a storage element electrically connected to the power receiving element.

18. The object with a rotational effect as claimed in claim 4, wherein the first inner object further comprises a storage element electrically connected to the power receiving element.

19. The object with a rotational effect as claimed in claim 5, wherein the first inner object further comprises a storage element electrically connected to the power receiving element.

20. The object with a rotational effect as claimed in claim 7, further comprising a storage element disposed in the second enclosure and electrically connected to the power receiving element.
